(19) United States
(12) Patent Application Publication
(10) Pub. No.: US 2007/0209984 A1
(43) Pub. Date: Sep. 13, 2007

(54) Water Purifier

(75) Inventors: Mordechai Lev, West Bloomfield, MI (US); Roman S. Ferber, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: FKA DISTRIBUTING CO. D/B/A HOMEDICS, INC., Commerce Township, MI (US)

(21) Appl. No.: 11/684,352

(22) Filed: Mar. 9, 2007

Related U.S. Application Data
(60) Provisional application No. 60/780,579, filed on Mar. 9, 2006.

(51) Int. Cl. B01D 21/30

(52) U.S. Cl. 210/143; 210/192; 210/295; 210/473; 422/186.3

(57) ABSTRACT

A water purifier system is provided including a housing having a first, upper reservoir and a second, lower reservoir. A filter cartridge is arranged to be received within the housing, the filter cartridge having at least one inlet for receiving water from the first reservoir and at least one outlet for dispensing water into the second reservoir. A UV source is disposed within the second reservoir for purifying the water contained therein, and a control interface is removably connected to the housing for controlling the operation of the UV source.

### CROSS-REFERENCE TO RELATED APPLICATIONS

This application claims the benefit of U.S. provisional application Ser. No. 60/780,579 filed Mar. 9, 2006, which is incorporated by reference herein.

### BACKGROUND OF THE INVENTION

1. Field of the Invention

This invention relates to point-of-use water purifiers and filters for use therewith.

2. Background Art

Water purifiers for consumer use, such as pitchers, are known in the art. Such pitchers typically have upper and lower chambers separated by a carbon filter or the like. Water is introduced into the upper chamber, flows by the force of gravity through the filter, and is received in the lower chamber after filtering. While these water purifiers may remove particulate matter, they do not effectively kill bacteria, viruses, and molds which may be present in the water. In some consumer units, attempts have been made to address this problem by irradiating water with ultraviolet light, but the resulting purifier units are often over-complicated, expensive, and cumbersome to use, and still may not be entirely effective in eliminating impurities.

### BRIEF DESCRIPTION OF THE DRAWINGS

FIG. 1 is a side elevational view of a water purifier according to an aspect of the present invention;

FIG. 2 is a partial top perspective view of the water purifier of FIG. 1;

FIG. 3 is a perspective view of the water purifier housing according to an aspect of the present invention;

FIG. 4 is an exploded view of the water purifier of FIG. 1;

FIG. 5 is a cross-sectional view of a water purifier according to the present invention taken along line 5-5 of FIG. 2;

FIG. 6 is a cross-sectional view of the water purifier taken along line 6-6 of FIG. 5;

FIG. 7 is a cross-sectional view of the water purifier taken along line 7-7 of FIG. 5;

FIG. 8 is a perspective view of a base which may be used with the water purifier according to an aspect of the present invention;

FIG. 9 is a perspective view of the water purifier according to the present invention placed on the base;

FIG. 10 is a front elevational view of an adapter which may be used with the water purifier according to an aspect of the present invention;

FIG. 11 is a rear perspective view of the adapter of FIG. 10;

FIG. 12 is a top perspective view of another embodiment of an adapter which may be used with the water purifier according to an aspect of the present invention;

FIG. 13 is a front elevational view of the adapter of FIG. 12;

FIG. 14 is a perspective view of an adapter according to the present invention connected to the water purifier;

FIG. 15 is a front elevational view of a filter cartridge which may be used with the water purifier according to an aspect of present invention;

FIG. 16 is a top plan view of the filter of FIG. 15;

FIG. 17 is a partial bottom perspective view of the filter of FIG. 15;

FIG. 18 is a block diagram depicting control electronics for the water purifier according to an aspect of the present invention.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present invention.

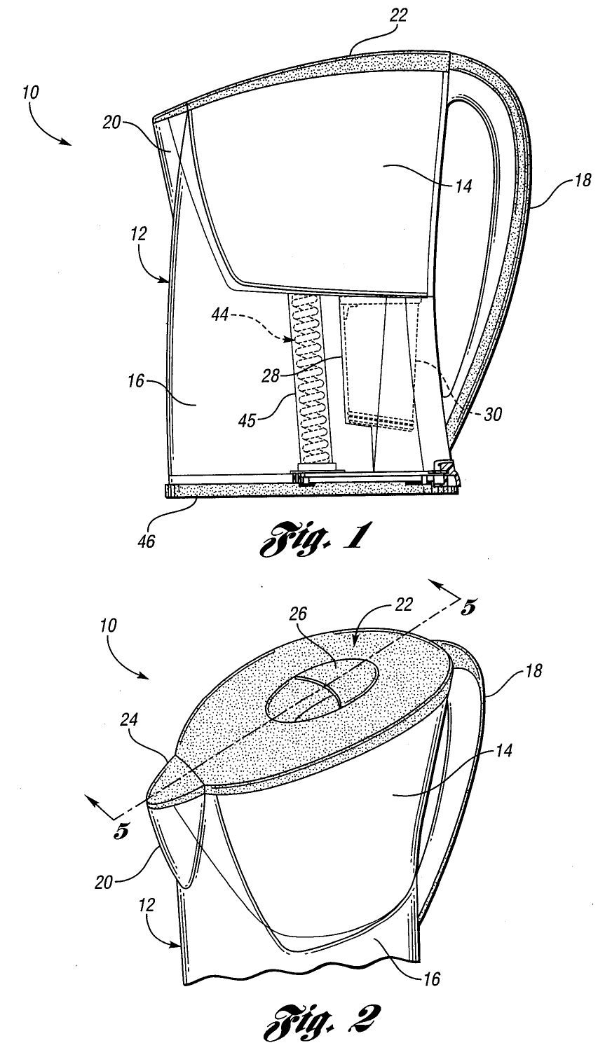

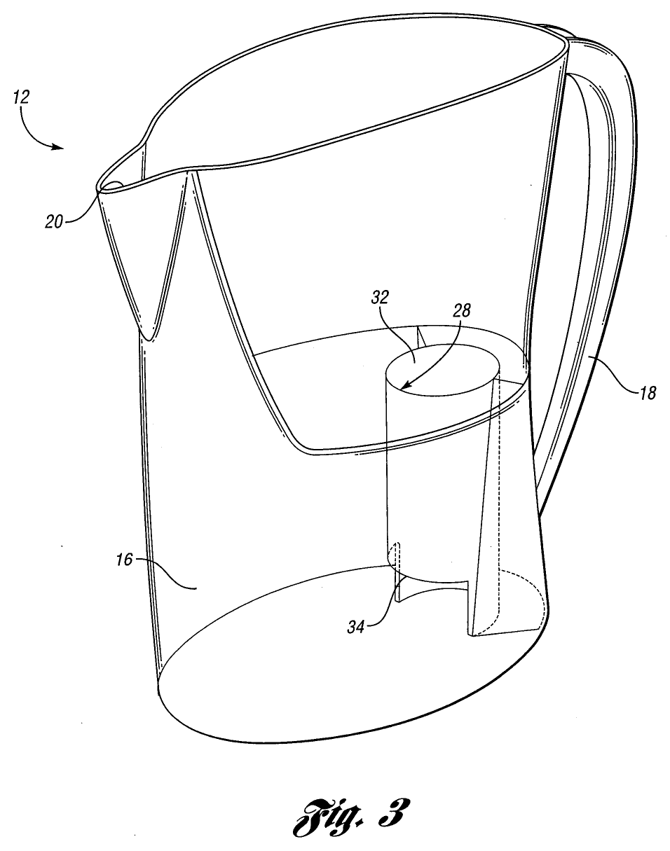

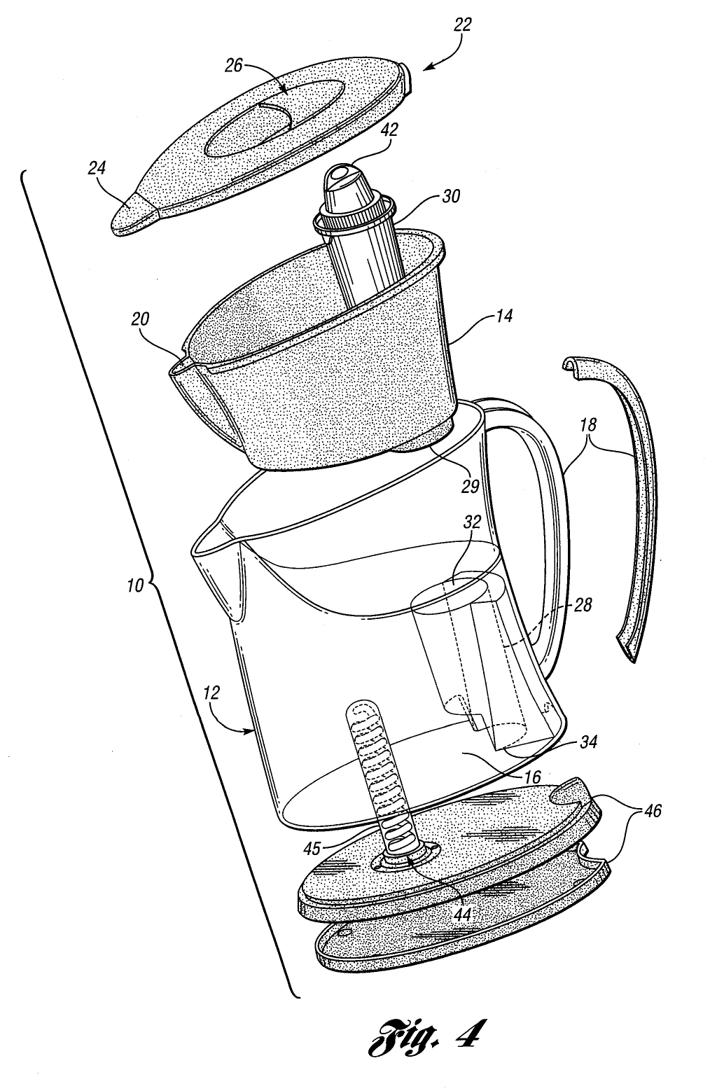

With reference to FIGS. 1-5, a water purifier according to the present invention is depicted and designated generally by reference numeral 10. Water purifier 10 may be designed in the form of a portable and refillable pitcher for receiving, purifying, and dispensing water or another fluid. Of course, embodiments of water purifier 10 other than a pitcher configuration are also fully contemplated. Water purifier 10 may include a housing 12 having a first, upper reservoir 14 and a second, lower reservoir 16. First reservoir 14 may be removable from housing 12 or alternatively may be integrally molded therewith.

According to one non-limiting aspect of the present invention, first reservoir 14 may be configured to hold at least 1250 ml of fluid, and second reservoir 16 may be configured to hold at least 2250 ml of fluid. In general, water purifier 10 may have approximately a 10 cup capacity. Regardless of the volume capacity of first and second reservoirs 14, 16, the capacity of second reservoir 16 may be at least as great as the capacity of first reservoir 14. Water purifier housing 12 may be constructed from UV stable, food contact grade plastics. According to an aspect of the present invention, housing 12 may be constructed from a material that is transparent to ambient light and opaque to ultraviolet (UV) light, for example, but not limited to, a clear or frosted plastic material. In one embodiment, first reservoir 14 may be constructed from a material opaque to ambient light as well as UV light, for example, but not limited to, a non-transparent plastic material. Such a material choice for first reservoir 14 may block direct viewing of UV light as described in greater detail below.

With continuing reference to FIGS. 1-5, water purifier 10 may further include a handle 18 for ease of handling, and a spout 20 in fluid communication with second reservoir 16 for dispensing purified water. A lid 22 may be provided to at least partially cover first reservoir 14, wherein lid 22 may be removable or mounted to housing 12, such as in a hinged fashion. Furthermore, lid 22 may have a portion 24 which removably covers spout 20, such as via a hinged connection. Lid 22 may also include a handle 26 provided therein for ease of removal from housing 12. Of course, it is understood that variations to the above configuration are fully contemplated in accordance with the present invention.

As shown in FIGS. 1 and 3-5, housing 12 includes a receptacle 28 disposed, affixed, or integrally molded therein for removably receiving a filter cartridge 30. According to one aspect of the present invention, receptacle 28 may be disposed along a wall of housing 12 within second reservoir 16, although other locations may be utilized in accordance with the present invention. First reservoir 14 may include an opening 29 for receiving filter cartridge 30 which, when seated, extends into second reservoir 16. As shown, receptacle 28 has a first opening 32 in communication with first reservoir 14, and a second opening 34 in communication with second reservoir 16. Filter cartridge 30 may be seated within receptacle 28 such that a water-tight seal exists between receptacle 28 and first reservoir 14, ensuring that water cannot get into second reservoir 16 without passing through filter cartridge 30. Sealing means, such as O-rings 36, may also be provided adjacent second opening 34 to create an air- and water-tight seal between receptacle 28 and filter cartridge 30 to ensure that water from second reservoir 16 cannot flow backwards into first reservoir 14, and also prevents water from getting between filter cartridge 30 and receptacle 28.

One advantage of the location and seal of filter cartridge 30 within receptacle 28 of the present invention may be that any shadowing from filter cartridge 30 within second reservoir 16 is avoided, thus exposing all areas of second reservoir 16 to a UV source contained therein and improving the removal of impurities as described below. In addition to the location of filter cartridge 30 described above, filter cartridge 30 could be disposed horizontally within housing 12 at any location above the UV source (described below), or any other suitable location. Furthermore, a motor (not shown) could be utilized to rotate filter cartridge 30, which may extend the life of filter cartridge 30 or allow for a smaller filter cartridge 30 to be utilized, thus providing greater capacity of second reservoir 16.

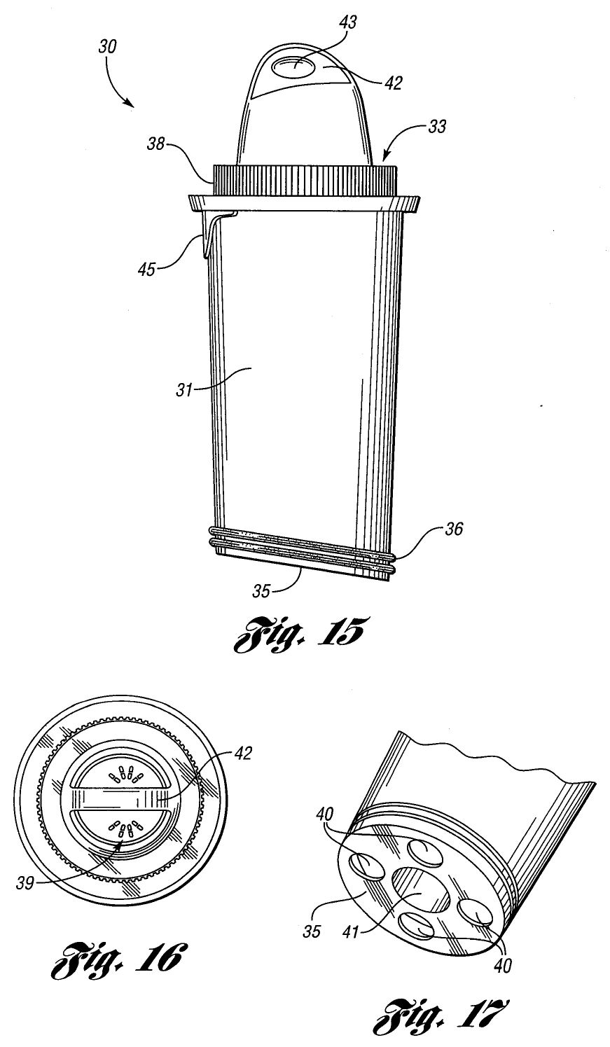

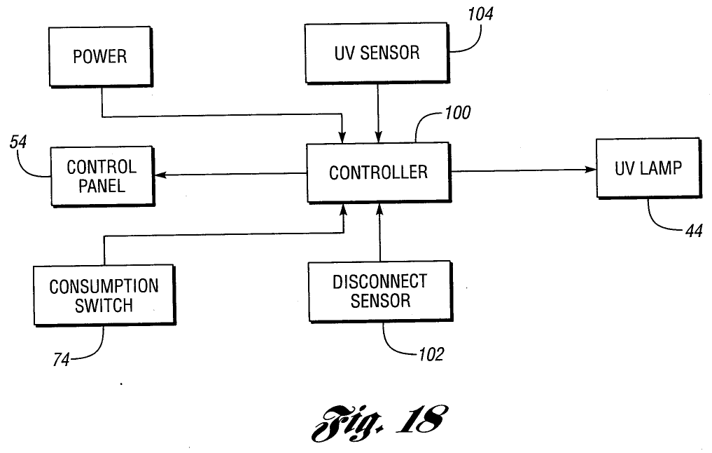

According to one aspect of the present invention, filter cartridge 30 may be a replaceable, gravity-type filter cartridge, wherein water provided in first reservoir 14 flows through filter cartridge 30 by the action of gravity into second reservoir 16. As best shown in FIGS. 15-17, filter cartridge 30 includes a filter housing 31 having a first end 33 and a second end 35. Water or other fluid from first reservoir 14 may flow into filter 30 via at least one inlet 38 at first end 33, may be processed within filter 30 for the removal of impurities, and may be dispensed into second reservoir 16 via at least one outlet 40 at second end 35. Four outlets 40 are depicted herein, although it is understood that filter cartridge 30 according to the present invention is not limited to this configuration. An air vent 39 (FIG. 16) and a flow director 41 (FIG. 17) may also be provided. Filter cartridge 30 may have, but is not limited to, a life of 40 gallons of fluid processed, and may be disposable. Filter cartridge 30 may accomplish the removal of water impurities by use of any filter media or material as is known in the art such as, but not limited to, carbon/ion resin which may include a bacteriostatic material, such as silver. Filter cartridge 30 may also include a handle 42 and optional finger grip 43 for ease of insertion into and removal from receptacle 28 by the user. Still further, filter cartridge 30 may include a key member 45 arranged to be received by receptacle 28 to ensure insertion of filter 30 in a proper orientation. Filter cartridge 30 may be generally elongate and cylindrical as shown, or any other suitable shape.

As shown, filter second end 35 may be angled with respect to filter first end 33, such that ends 33, 35 are not parallel. In addition, receptacle second opening 34 may also be generally angled with respect to receptacle first opening 32. The angled second end 35 may create a pathway for bubbles that accumulate under outlet(s) 40 to escape upward. Moving air bubbles away from outlets 40 may help to maintain good water flow because air bubbles create resistance to flow. Furthermore, the angled second end 35 of filter 30 in conjunction with the angled second opening 34 of receptacle 28 may eliminate light shadows, as this configuration opens up the area beneath receptacle 28 to allow the UV light (described below) to penetrate therein.

Water purifier 10 according to the present invention may include a UV source such as a UV lamp 44 provided within second reservoir 16 for irradiating the water or other fluid contained therein with UV light in order to eliminate impurities (e.g., organic matter, bacteria). According to one non-limiting aspect of the present invention, UV lamp 44 may comprise a long-life, cold cathode, spiral design UVC germicidal bulb. UV lamp 44 may be visible through housing 12 such that a user can determine that it is operational. In one embodiment, the volume of water contained in second reservoir 16 may completely submerge UV lamp 44. UV lamp 44 may be mounted to a bottom plate 46 which can be affixed to water purifier housing 12 via sonic welding or other methods to create a water-tight seal, but is not limited to this mounting configuration. According to one aspect of the present invention, UV lamp 44 may be mounted generally centrally within second reservoir 16. Of course, it is contemplated that UV lamp 44 could alternatively have another location within water purifier 10.

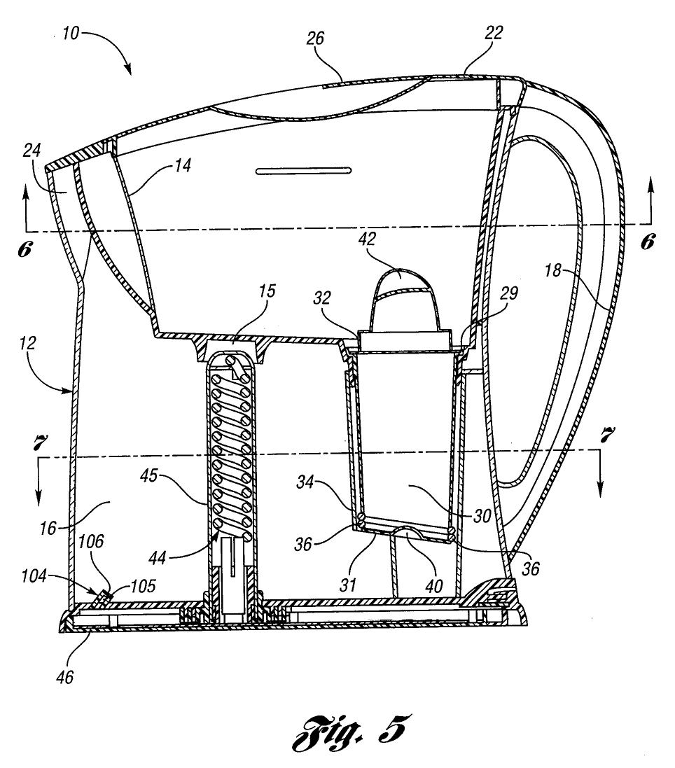

UV lamp 44 may be surrounded by a protective, water-tight, shield such as quartz sleeve 45 which may be cleaned by a user by removing lid 22 and first reservoir 14. As best shown in FIG. 5, first reservoir 14 may include a hood 15 on an underside thereof which may receive and locate UV lamp 44. UV lamp 44 may have any size and intensity specifications suitable for its intended use. In one embodiment, a light source (not shown), such as LEDs, may be provided adjacent to UV lamp 44 and be configured to illuminate when power is supplied to UV lamp 44 to give the user a visual indication that UV lamp 44 is in operation. The components of water purifier 10 discussed above are further shown in the cross-sectional views of FIGS. 6 and 7.

In accordance with further aspects of the present invention, water purifier 10 may include a motor and pump (not shown) for circulating water through second reservoir 16. In another embodiment, a heat source (not shown) could be provided within second reservoir 16, wherein water from an area near the heat source would naturally flow toward a colder area of second reservoir 16, thus creating circulation. In yet another embodiment, a motor may be provided with a submerged impeller (not shown) for stirring the water and creating circulation of the water within second reservoir 16.

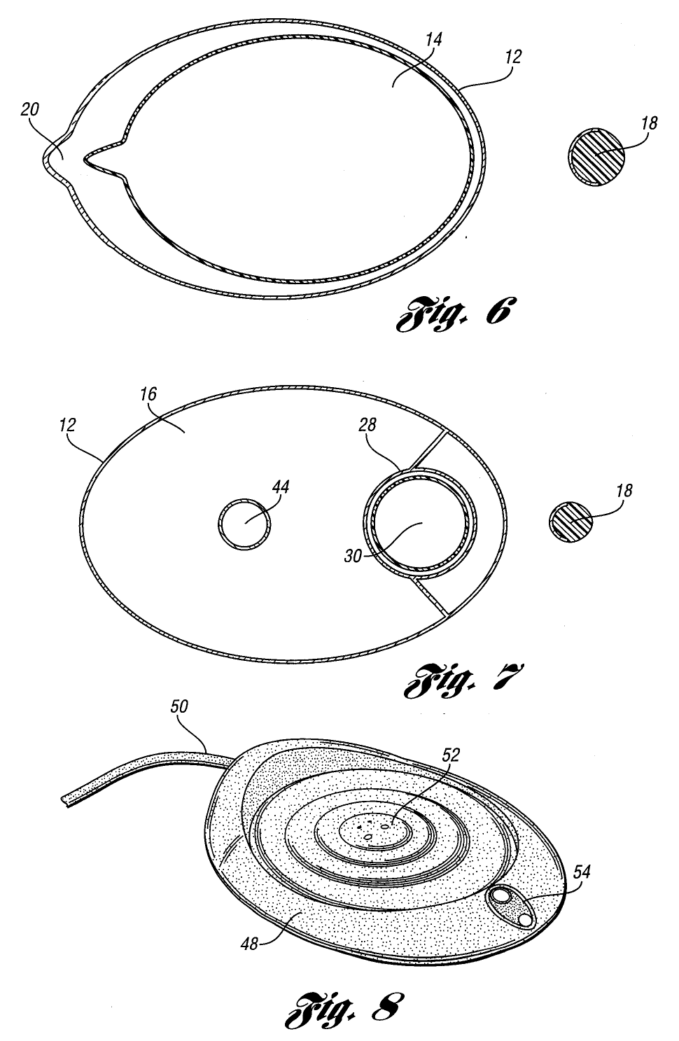

With reference to FIGS. 8 and 9, a control interface such as a base 48 may be provided to receive water purifier 10 for controlling its operation, thus providing a water purifier system. Base 48 may include a power cord 50 for connection to a standard wall outlet, or alternatively may be powered by batteries or a rechargeable source. Base 48 may also include a storage area (not shown) for receiving power cord 50 when not in use. According to one aspect of the present invention, base 48 may include electrical contacts 52 of any configuration which are intended to mate with corresponding contacts (not shown) provided on a bottom surface of bottom plate 46. Contacts 52 may be in communication with a controller 100 housed in base 48 and illustrated schematically in FIG. 18 for controlling the operation of UV lamp 44 and other components of water purifier 10. A control panel 54 for receiving user input as to the operation of water purifier 10 and for displaying output signals may be provided on base 48 and in communication with controller 100 housed therein.

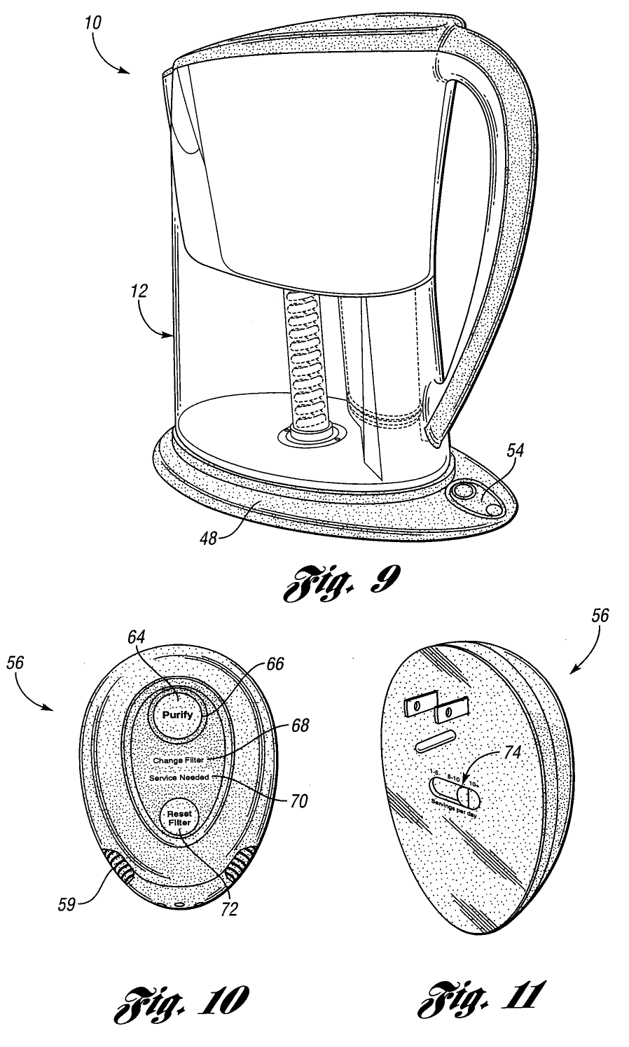

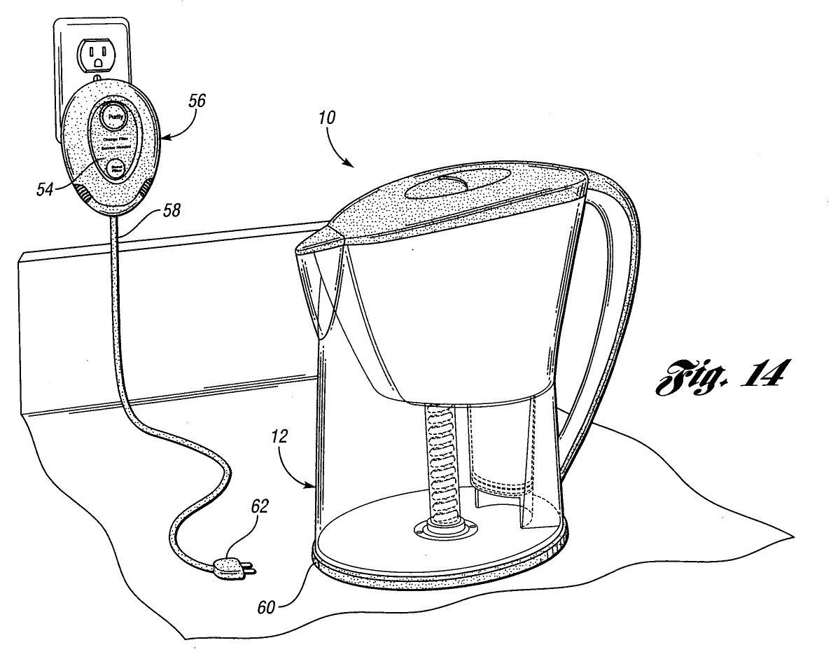

Turning now to FIGS. 10-14, in accordance with another aspect of the present invention, an adapter 56 may be provided as a control interface to provide power to water purifier 10 and contain controller 100 and control panel 54. In this embodiment, adapter 56 may be configured to be received in a standard wall outlet for providing power, although battery-operated and rechargeable embodiments are also fully contemplated. Adapter 56 may be provided with a cord 58, such as with a polarized electrical connector for only plugging in one way to housing 12, for connection with water purifier 10. Cord 58 may be retractable into the housing of adapter 56, as best shown in FIG. 13, such as by operation of a power cord rewind button 59. Cord 58 may be coiled to facilitate retraction into adapter 56. As shown in FIG. 14, water purifier housing 12 may include a mating area 60 for connection with an end 62 of cord 58. Base 48 or adapter 56 may include a battery back-up to provide power to controller 100 and associated electronics when base 48 or adapter 56 is not plugged in.

Control panel 54 will now be described, wherein features are similar for both the base 48 and adapter 56 embodiments. According to one aspect of the present invention, control panel 54 may include a power (“Purify”) button 64 which, when depressed by a user, may supply power to UV lamp 44 for the purpose of purifying water or other fluid contained within second reservoir 16. Button 64 may include an outer ring 66, such as of LEDs, which can be illuminated when UV lamp 44 is in operation. A “Change Filter” indicator 68 may be provided for indicating that filter cartridge 30 should be changed, as described further below. A “Service Needed” indicator 70 may be provided to indicate any failure of UV lamp 44. A “Reset Filter” button 72 may be provided which, upon depression by a user for a selected period of time (e.g., 5 seconds) resets the filter timer as described below and switches off the “Change Filter” indicator 68, typically after changing the filter. Of course, control panel 54 is not limited to the above buttons and indicators, and other features (for example, a timer function) are fully contemplated in accordance with the present invention.

Upon depressing the “Purify” power button 64, UV lamp 44 may be activated for a designated period of time (for example, but not limited to, 1 minute) to purify water within water purifier 10 during a purification cycle. When the purification time has elapsed, UV lamp 44 may be configured to turn off automatically, and a signal indication may be provided to the user, such as ceasing illumination of LED ring 66, illuminating ring 66 with a different color, sounding an audible signal, or any other indication. The user may depress the “Purify” button 64 additional times to initiate additional purification cycles if desired, which may exponentially increase the purifying effect. In one embodiment, a sensor 102 (FIG. 18) may be provided in base 48 or adapter 56 to determine if water purifier 10 is disconnected therefrom, such as in order for a user to consume the purified water. If a predetermined period of time elapses without consumption of the purified water, controller 100 may be operable to turn UV lamp 44 on for a period of time to maintain a purified water condition or to provide a signal indication to the user that he/she may wish to re-purify the water before consumption.

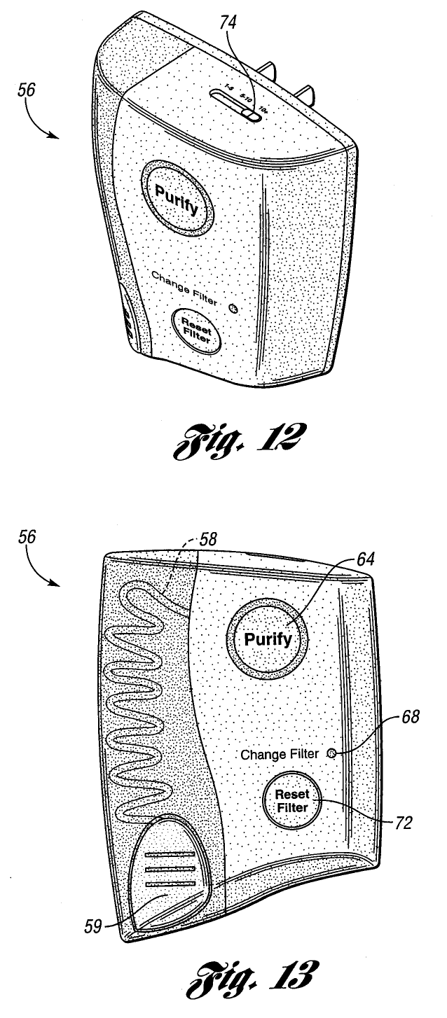

With reference to FIGS. 11 and 12, both base 48 and adapter 56 may include a consumption switch 74 in communication with controller 100 which allows a user to select a typical number of servings (for example, but not limited to, 8 oz. glasses) of water or other fluid they require in a given day. For example, as best shown in FIG. 11, switch 74 may allow a user to select 1-5 cups per day, 5-10 cups per day, 10+ cups per day, or any other amount. Accordingly, depending upon the life of filter cartridge 30, the setting of switch 74 may determine the number of days elapsed before the “Change Filter” indicator 68 is illuminated. For example, setting switch 74 to 1-5 cups per day may cause controller 100 to illuminate the “Change Filter” indicator 68 after approximately 4 months, setting switch 74 to 5-10 cups per day may cause controller 100 to illuminate the “Change Filter” indicator 68 after approximately 3 months, and setting switch 74 to 10+ cups per day may cause controller 100 to illuminate the “Change Filter” indicator 68 after approximately 2 months. Of course, these settings are merely exemplary, and any consumption time periods or units are fully contemplated. Should a user change the setting of switch 74 at any time, controller 100 may accurately recalculate a new end of life of filter cartridge 30, which may be based upon the number of days elapsed at a previous consumption rate setting or settings.

In further accordance with the present invention, as shown in FIGS. 5 and 18, a UV sensor 104 may be provided for detecting the germicidal output of UV lamp 44 (e.g., UV at a 254 nm wavelength). UV sensor 104 may be provided in communication with controller 100 for providing an alarm to the user if there is insufficient UV dosage during a UV irradiation cycle. In one embodiment, the alarm may be “Service Needed” indicator 70, but could have any location in or on water purifier 10, base 48, or adapter 56. UV sensor 104 may have any suitable configuration such as, but not limited to, a surface mount sensor or TO 5, TO 18, TO 39, or TO 46 sizes, and may include a photocell 105 assembled inside a waterproof housing (e.g., metal with a viewing window 106, such as quartz). Controller 100 may include an analog or digital detection circuit and optional amplifier in communication with photocell 105 of UV sensor 104, wherein a light filter may also be utilized to further optimize the response. According to one non-limiting aspect of the present invention, photocell 105 of UV sensor 104 may be submerged in the fluid contained within second reservoir 16 during operation, and may be located as far away from UV lamp 44 as possible to maximize the path length therebetween. Accordingly, one location for UV sensor 104 may be close to a bottom rear of pitcher housing 12 with viewing window 106 facing generally directly at UV lamp 44. However, it is understood that UV sensor 104 may be mounted at other locations within water purifier 10, such as at the base of UV lamp 44 with viewing window 106 pointed generally directly upward, or any other location where UV sensor 104 is effective in detecting UV light during a purification cycle.

In operation, a user may place water into first reservoir 14, wherein water will flow through filter cartridge 30 and into second reservoir 16 for additional purification by UV lamp 44 as initiated by the user. Purified water may be poured out of housing 12 via spout 20. Water purifier 10 according to the present invention can be removed from base 48 or disconnected from adapter 56 and placed in the refrigerator for cooling the water stored therein, or placed on a table or counter top for use. One advantage of the present invention may be that the control electronics and control panel 54 are housed in base 48 or adapter 56, and not in water purifier 10 itself. In this way, the control electronics are not subjected to the changing environmental conditions between room temperature air, refrigerated air, or another location.

Although specific base 48 and adapter 56 configurations have been shown and described herein, it is understood that water purifier 10 according to the present invention is not limited to these embodiments, and that other possible control interfaces are also fully contemplated.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A water purifier system, comprising:
a housing having a first, upper reservoir and a second, lower reservoir;
a filter cartridge arranged to be received within the housing, the filter cartridge having at least one inlet for receiving water from the first reservoir and at least one outlet for dispensing water into the second reservoir;
a UV source disposed within the second reservoir for purifying the water contained therein; and
a control interface removably connected to the housing for controlling the operation of the UV source.

2. The system according to claim 1, wherein the housing comprises a pitcher.

3. The system according to claim 1, wherein the first reservoir is removable from the housing.

4. The system according to claim 1, wherein the housing includes a handle.

5. The system according to claim 1, further comprising a lid at least partially covering the first reservoir.

6. The system according to claim 1, wherein the housing includes a receptacle within the second reservoir arranged to receive the filter cartridge.

7. The system according to claim 6, wherein the receptacle is disposed along a wall of the housing.

8. The system according to claim 6, further comprising sealing means disposed between the receptacle and the filter cartridge.

9. The system according to claim 6, wherein the receptacle includes a first opening in communication with the first reservoir and a second opening opposite the first opening and in communication with the second reservoir, the second opening angled with respect to the first opening.

10. The system according to claim 1, wherein the filter cartridge includes a filter housing having a first end and a second end, wherein the second end is angled with respect to the first end.

11. The system according to claim 10, wherein the filter housing includes a key member arranged to be received by the water purifier housing to ensure proper orientation of the filter cartridge therein.

12. The system according to claim 1, wherein the filter cartridge includes filter media comprising a carbon/ion resin.

13. The system according to claim 1, wherein the UV source is mounted to a bottom plate of the housing.

14. The system according to claim 1, wherein the UV source is mounted generally centrally within the second reservoir.

15. The system according to claim 1, wherein the UV source is surrounded by a water-tight shield.

16. The system according to claim 1, wherein the first reservoir includes a hood on an underside thereof arranged to receive and locate the UV source.

17. The system according to claim 1, wherein the control interface includes a base arranged to receive the housing thereon.

18. The system according to claim 1, wherein the control interface includes an adapter arranged to be connected to the housing.

19. The system according to claim 18, wherein the adapter includes a retractable power cord for connecting to the housing.

20. The system according to claim 1, wherein the control interface includes a controller and a control panel in communication therewith for receiving user input and displaying output signals.

21. The system according to claim 20, wherein the control panel includes an indicator for alerting a user that the filter cartridge should be changed.

22. The system according to claim 20, wherein the control panel includes an indicator that the UV source is in operation.

23. The system according to claim 20, wherein the control interface includes a user-selectable switch in communication with the controller for selecting a consumption rate of water.

24. The system according to claim 20, further comprising a UV sensor in communication with the controller for sensing an output of the UV source.

25. The system according to claim 24, wherein the UV sensor is disposed in the second reservoir spaced from the UV source.

26. A water purifier system, comprising:
a pitcher housing having a removable upper reservoir and a lower reservoir, the lower reservoir including a receptacle disposed along a wall thereof;
a filter cartridge arranged to be received at least partially within the receptacle, the filter cartridge having at least one inlet for receiving water from the first reservoir and at least one outlet for dispensing water into the second reservoir, the filter cartridge having a filter housing including a first end and a second end, the second end angled with respect to the first end;
a UV lamp disposed within the second reservoir for purifying the water contained therein;
an adapter removably connected to the housing, the adapter including a user-selectable switch for selecting a consumption rate of water; and
a controller disposed within the adapter in communication with the UV lamp and the switch for controlling the operation of the UV lamp and determining a life of the filter cartridge based on a selected consumption rate.

27. A filter cartridge for use in a water purifier system, the filter comprising:
a filter housing having a first end and a second end, the second end angled with respect to the first end;
filter media provided within the filter housing for purifying water flowing therethrough;
at least one inlet disposed at the first end for receiving water into the filter housing; and
at least one outlet disposed at the second end for dispensing water from the filter housing.

28. The filter cartridge according to claim 27, further comprising a key member disposed on the filter housing and arranged to be received by the water purifier system for orienting the filter cartridge.

29. The filter cartridge according to claim 27, wherein the first end includes a handle.

30. The filter cartridge according to claim 27, wherein the first end includes an air vent.

31. The filter cartridge according to claim 27, wherein the filter housing is generally cylindrical.
